(19) United States
(12) Patent Application Publication
(10) Pub. No.: US 2002/0185070 A1
(43) Pub. Date: Dec. 12, 2002

(54) Device for performing one or more animal related treatments on an animal

(75) Inventors: Elena Espada Aventin, Rotterdam (NL); Karel van den Berg, Bleskensgraaf (NL)

Correspondence Address: Penrose Lucas Albright, Esq., MASON, MASON & ALBRIGHT, P.O. Box 2246, Arlington, VA, 22202-0246, US

(73) Assignee: LELY ENTERPRISES A.G.

(21) Appl. No.: 10/163,601

(22) Filed: Jun. 7, 2002

(30) Foreign Application Priority Data
Jun. 8, 2001 (NL) 1018241
Dec. 7, 2001 (NL) 1019515

(51) Int. Cl. A01J 3/00; A01J 5/00

(52) U.S. Cl. 119/14.1

(57) ABSTRACT

A device for performing one or more animal related treatments on an animal out of a group of animals which are allowed to walk around in an area intended therefor and are able to visit the device voluntarily is provided with means for influencing at least one animal related treatment in dependence of the value of a parameter which is an indication of the expected waiting time for an animal wanting to visit the device. This results in a better utilisation of the capacity of the device. A device for automatically milking animals which are allowed to walk around in an area intended therefor and are able to visit the device voluntarily is provided with a milking robot and is suitable for deciding on the basis of an admission criterion with at least one requirement whether an animal is allowed to visit the milking robot, and/or is suitable for deciding on the basis of a milking criterion with at least one requirement whether or not an animal visiting the milking robot will be milked. The device is provided with means for varying the requirement or requirements of the admission criterion and/or the milking criterion in dependence of the value of a parameter which is an indication of the expected waiting time for an animal wanting to visit the device. This results in a better utilisation of the capacity of the device.

The invention relates to a device according to the preamble of claim 1.

Such a device is known and may comprise e.g. a milking robot for fully automatically milking dairy animals or an automatic feeding installation. The animals visiting the device voluntarily may be recognised there e.g. by means of an animal identification system, after which they are milked or fed.

The known device has i.a. the disadvantage that the capacity of the device is not utilised optimally. The visiting frequency of the animals to the device is not constant in the course of time. In some periods many animals, in other periods few animals want to visit the device. This may result in long waiting times for the animals at certain points of time. It is both in the interest of the animals and in the interest of the user of the device that the capacity of the device is utilised to a highest possible extent.

The invention aims at improving such a device. According to the invention this is achieved by the measures in the characterizing part of claim 1. The invention is based on the insight that, by influencing the treatment(s) to be performed in dependence of the expected waiting time, it may be achieved that a treatment is performed differently or more quickly in busy times, whereas the animals can be treated more extensively or more slowly in quiet times. This results in a better utilisation of the capacity of the device.

As already partially described in the foregoing, the animal related treatments may comprise e.g. milking and/or feeding, but also inspecting, cleaning, stimulating and/or massaging.

The means for influencing the treatment(s) may comprise e.g. a computer which is suitable for selecting a treatment out of a number of possibilities and/or adjusting and/or changing a treatment as regards its duration (and/or nature and/or intensity). This may take place before the beginning of the treatment, but also during the treatment.

Because the (expected) waiting time cannot always simply be measured directly, there may also be used an indicative parameter which is known or can easily be determined. The parameter may be a measurable or a known, given quantity (which is known on the basis of historical data), such as the (expected) number of animals having to wait at the device or the (expected) visiting frequency of the animals to the device or the (expected) degree of occupation of the device. The momentary, current value of the parameter varying in time can thus be measured or be known on the basis of historical data.

The invention further relates to a device according to the preamble of claim 19.

Such a device is known. The animals visiting the device voluntarily are admitted when the requirement(s) of the admission criterion has/have been met and/or milked when the requirement(s) of the milking criterion has/have been met. A requirement may be e.g. that at least a certain period of time has elapsed since the last milking of the relevant animal, or that the expected milk yield of the animal is above a certain threshold value. The known device has i.a. the disadvantage that the capacity of the device is not utilised optimally. The visiting frequency of the animals to the device is not constant in the course of time. In some periods many animals, in other periods few animals want to visit the device. This may result in long waiting times for the animals at certain points of time. It is both in the interest of the animals and in the interest of the user of the device that the capacity of the device is utilised to a highest possible extent.

The invention aims at improving such a device. According to the invention this is achieved by the measures in the characterizing part of claim 19. The invention is based on the insight that by regulating the admission and/or the milking criterion in dependence of the expected waiting time it may be achieved that animals are sooner refused in busy times, whereas the animals can be milked more frequently in quiet times. This results in a better utilisation of the capacity of the device.

The invention will be explained in further detail with reference to some embodiments.

The device for automatically milking animals is suitable for successively receiving individual animals out of a group of animals which are allowed to walk around freely in an area intended therefor and are able to visit the device individually and voluntarily. The device is provided with means for stimulating the animals to visit the device, such as a concentrate box, sufficiently often. The device is further provided with teat cups and with a milking robot known per se for automatically connecting the teat cups to the teats of an animal to be milked. There may be provided animal identification means for identifying the animals, e.g. when they visit the device.

In an embodiment the device is suitable for stopping the milking of an animal when the milk flow measured in an udder quarter has come below a certain threshold value during at least a certain period of time. As soon as this is the case, the relevant teat cup can be disconnected from the teat. Each teat cup of the device thus has a disconnection limit which may vary per animal and per teat.

According to an aspect of the invention the device is provided with means for varying the threshold value in dependence of the expected waiting time of the animals at the device. When the expected waiting time of the animals at the device is known or has been measured, the threshold value for stopping the milking is adjusted accordingly. When the expected waiting time is short the means adjust the threshold value at a lower level than when the expected waiting time is long. Thus the duration of a milking run becomes shorter in busy times, whereas the animals can be milked for a longer time in quiet times. This results in a better utilisation of the capacity of the device. The means are preferably suitable for adjusting the threshold value for each animal individually and per teat separately.

In a further embodiment the device is provided with means which are suitable for influencing the duration and/or the intensity of the milking by varying the vacuum level in the milk lines and/or the pulsation frequency in the pulsation lines.

In again a further embodiment the means are suitable for influencing the duration of the milking by taking per milking only maximally a certain, adjustable amount of milk, said amount being adjustable in dependence of the (expected) waiting time.

In a still further embodiment the means are suitable for influencing the duration and/or the nature and/or the intensity of the cleaning of the teats.

In a further embodiment the device is suitable for deciding on the basis of a milking criterion with at least one requirement whether or not an animal visiting the milking robot will be milked. The milking criterion may require e.g. that when the animal visits the device the expected milk yield of the animal is above a certain threshold value (e.g. 8 kg). Instead of the milking criterion there may also be used in an analogous manner an admission criterion by means of which it is decided whether an animal is allowed to visit the milking robot.

According to a further aspect of the invention the device is provided with means for varying the requirement or requirements of the milking criterion in dependence of the expected waiting time of the animals at the device. When the expected waiting time of the animals at the device is known, the milking criterion is adjusted accordingly. When the expected waiting time is short the means adjust the requirement or requirements of the milking criterion less strictly than when the expected waiting time is long. For example, the limit of 8 kg may be lowered to 6 kg at night in a quiet period and may be raised to 10 kg in the morning in a busy period. Thus animals are refused sooner in busy times, whereas the animals can be milked more frequently in quiet times. This results in a better utilisation of the capacity of the device. The means are preferably suitable for adjusting the requirement or requirements of the milking criterion for each animal individually.

A (possibly periodically recurring) pattern in time of the expected visiting frequency and/or a (possibly periodically recurring) pattern in time of the (expected) number of animals having to wait at the device for visiting same may be stored in the device, e.g. in the memory of a computer. The pattern may be measured by means of tests or may be known from the professional literature.

The device may also be provided with measuring means for determining a (possibly periodically recurring) pattern in time of the (expected) visiting frequency and/or of a (possibly periodically recurring) pattern in time of the (expected) number of animals having to wait at the device for visiting same. The measuring means may comprise a computer registering the visiting frequency and/or the number of animals and possibly storing the pattern in time. In this manner the device is capable of generating independently the necessary data in relation to the expected waiting time. Optionally it is possible to measure the pattern again, e.g. each time when a period of a month has elapsed. Possibly there may then be found another pattern (e.g. as a result of habituation of the animals). Due to the repeated measurements there are always found current, relevant measurement results.

In a preferred embodiment of the invention the device is provided with counting means for determining the expected number of visits of animals to the device in the near future. This is a cheap and simple manner to determine the expected degree of occupation of the device. The device may be provided with a waiting area for the animals wanting to visit the milking robot, the counting means being provided at the entrance of the waiting area.

The invention also relates to an above-mentioned device for performing at least one animal related treatment, the device not being one of the following devices: a device for automatically milking animals which are allowed to walk around freely in an area intended therefor and are able to visit the device individually, said device being provided with a milking robot and being suitable for stopping the milking of an animal when the milk flow has come below a certain threshold value, the device being provided with means for varying the threshold value in dependence of the expected visiting frequency of the animals to the device; a device for automatically milking animals which are allowed to walk around freely in an area intended therefor and are able to visit the device individually, said device being provided with a milking robot and being suitable for deciding on the basis of a milking criterion with at least one requirement whether or not an animal visiting the milking robot will be milked, the device being provided with means for varying the requirement or requirements of the milking criterion in dependence of the expected visiting frequency of the animals to the device.

1. A device for performing one or more animal related treatments on an animal out of a group of animals which are allowed to walk around in an area intended therefor and are able to visit the device voluntarily, characterized in that the device is provided with means for influencing at least one animal related treatment in dependence of the value of a parameter which is an indication of the expected waiting time for an animal wanting to visit the device.

2. A device as claimed in claim 1, characterized in that the means are suitable for influencing the duration and/or the nature and/or the intensity of the animal related treatment(s).

3. A device as claimed in claim 1 or 2, characterized in that the parameter is constituted by the visiting frequency and/or the expected visiting frequency of the animals to the device.

4. A device as claimed in claim 1 or 2, characterized in that the parameter is constituted by the number of animals being ready to visit the device or showing the intention to visit the device and/or by the number of animals having to wait at the device for visiting same and/or the expected number of animals having to wait at the device for visiting same.

5. A device as claimed in any one of claims 1 to 4, characterized in that the means shorten the duration of the animal related treatments) when the (expected) waiting time is long.

6. A device as claimed in any one of claims 1 to 5, characterized in that the means prolong the duration of the animal related treatment(s) when the (expected) waiting time is short.

7. A device as claimed in any one of claims 1 to 6, characterized in that a (possibly periodically recurring) pattern in time of the (expected) visiting frequency and/or a (possibly periodically recurring) pattern in time of the (expected) number of animals having to wait at the device for visiting same are/is stored in the device.

8. A device as claimed in any one of claims 1 to 7, characterized in that the device is provided with measuring means for determining a (possibly periodically recurring) pattern in time of the (expected) visiting frequency and/or a (possibly periodically recurring) pattern in time of the (expected) number of animals having to wait at the device for visiting same.

9. A device as claimed in any one of claims 1 to 8, characterized in that the device is provided with counting means for determining the expected number of visits of animals to the device in the near future.

10. A device as claimed in claim 9, characterized in that the device is provided with a waiting area for animals wanting to visit the milking robot, the counting means being provided at the entrance of the waiting area.

11. A device as claimed in any one of claims 1 to 10, characterized in that the device is provided with a milking robot and is suitable for stopping the milking of an animal when the milk flow has come below a certain threshold value, the means being suitable for influencing the duration of the milking by varying the threshold value.

12. A device as claimed in claim 11, characterized in that when the (expected) waiting time is short the means adjust the threshold value at a lower level than when the (expected) waiting time is long.

13. A device as claimed in claim 11 or 12, characterized in that the means are suitable for adjusting the threshold value for each animal individually.

14. A device as claimed in any one of claims 11 to 13, characterized in that the means are suitable for adjusting the threshold value for each animal per teat separately.

15. A device as claimed in any one of claims 1 to 14, provided with a milking robot, characterized in that the means are suitable for influencing the duration and/or the intensity of the milking by varying the vacuum level in the milk lines.

16. A device as claimed in any one of claims 1 to 15, provided with a milking robot, characterized in that the means are suitable for influencing the duration and/or the intensity of the milking by varying the pulsation frequency in the pulsation lines.

17. A device as claimed in any one of claims 1 to 16, provided with a milking robot, characterized in that the means are suitable for influencing the duration of the milking by taking per milking only maximally a certain, adjustable amount of milk, said amount being adjustable in dependence of the (expected) waiting time.

18. A device as claimed in any one of claims 1 to 17, provided with a milking robot, characterized in that the means are suitable for influencing the duration and/or the nature and/or the intensity of the cleaning of the teats.

19. A device for automatically milking animals which are allowed to walk around in an area intended therefor and are able to visit the device voluntarily, said device being provided with a milking robot and being suitable for deciding on the basis of an admission criterion with at least one requirement whether an animal is allowed to visit the milking robot, and/or is suitable for deciding on the basis of a milking criterion with at least one requirement whether or not an animal visiting the milking robot will be milked, characterized in that the device is provided with means for varying the requirement or requirements of the admission criterion and/or the milking criterion in dependence of the value of a parameter which is an indication of the expected waiting time for an animal wanting to visit the device.

20. A device as claimed in claim 19, characterized in that when the (expected) waiting time is short the means adjust the requirement or requirements of the admission criterion and/or the milking criterion less strictly than when the (expected) waiting time is long.

21. A device as claimed in claim 19 or 20, characterized in that the means are suitable for adjusting the requirement or requirements of the admission criterion and/or the milking criterion for each animal individually.
